(19) United States
(12) Patent Application Publication
(10) Pub. No.: US 2021/0355660 A1
(43) Pub. Date: Nov. 18, 2021

(54) WATER CIRCUIT PURGING SYSTEM

(71) Applicant: Mohamed Ferid Belkadhi, Montreal, Quebec (CA)

(72) Inventor: Mohamed Ferid Belkadhi, Montreal, Quebec (CA)

(21) Appl. No.: 17/284,197

(22) PCT Filed: Oct. 10, 2019
(86) PCT No.: PCT/CA2019/051444

§ 371 Date: Apr. 9, 2021

(30) Foreign Application Priority Data
Oct. 10, 2018 (GB) 1816560.5

(51) Int. Cl. E03B 7/08; E03B 7/00; E03B 7/07

(52) U.S. Cl. CPC E03B 7/08; E03B 7/071; E03B 7/003

(57) ABSTRACT

A water circuit purging system for purging water from a water circuit, comprising: a water discharge line; a flow directing device coupling a main water line to a water source and to the water discharge line, and movable between an operative configuration in which the main water line is in fluid communication with the water source, and a discharge configuration in which the main water line is in fluid communication with the water discharge line; a pump for pumping water from the water discharge line when the flow directing device is in the discharge configuration; a condition sensor for sensing a condition of the main water line; and a controller for receiving an indication of the sensed condition and to move the flow directing device from the operative configuration to the discharge configuration upon determination that the main water line is in a predetermined condition based on the sensed condition.

### TECHNICAL FIELD

The technical field generally relates to water circulation systems and more specifically to systems and methods for purging water from a water circuit.

### BACKGROUND

Water circuits or water systems are found in houses, commercial buildings, public buildings, aircrafts, passenger trains and the like. They allow water to be dispensed from a water source, such as a public water supply system or a water tank, to a water-using device or appliance, such as a toilet, a faucet for a sink and the like, through a plurality of water lines extending between the water source and the water-using appliance.

Unfortunately, if the temperature inside or around the water circuit drops below the freezing point of the water such that the water inside the water lines partially or completely freezes, the water may expand and damage the water lines, thereby causing water to leak down from the water lines. Water leaks from the water lines may also have other causes, such as wear or corrosion of the water lines. Regardless of their cause, water leaks can cause severe damage to a building and to the contents of the building.

There is therefore a need for a system which would alleviate at least one of the above-identified drawbacks.

### SUMMARY

According to one aspect, there is provided a water circuit purging system for purging water from a water circuit, the water circuit including a main water line having an inlet connected to a water source for dispensing water into the main water line, the system comprising: a water discharge line for evacuating water from the main water line; a flow directing device operatively coupling the main water line to the water source and the water discharge line, the flow directing device being movable between an operative configuration in which the main water line is in fluid communication with the water source to allow water to be provided in the main water line from the water source and in which fluid communication between the main water line and the water discharge line is prevented, and a discharge configuration in which fluid communication between the water source and the main water line is prevented and in which the main water line is in fluid communication with the water discharge line; a pump operatively coupled to the water discharge line for pumping water from the water discharge line to a water discharge outlet when the flow directing device is in the discharge configuration; a condition sensor for sensing a condition of the main water line; and a controller operatively connected to the condition sensor, to the flow directing device and to the pump, the controller being configured to receive an indication of the sensed condition from the condition sensor, to determine that the main water line is in a predetermined condition based on the sensed condition and to move the flow directing device from the operative configuration to the discharge configuration upon determination that the main water line is in the predetermined condition.

In one embodiment, the flow directing device comprises a directional valve.

In one embodiment, the directional valve is an electro-mechanical valve.

In one embodiment, the electro-mechanical valve is a three-way electro-mechanical valve.

In one embodiment, the water discharge outlet is operatively coupled to a domestic wastewater system.

In one embodiment, the water discharge outlet is operatively coupled to a discharge water reservoir for storing water evacuated from the main water line through the water discharge line.

In one embodiment, the discharge water reservoir includes an extendable sidewall.

In one embodiment, the discharge water reservoir includes a flexitank.

In one embodiment, the controller includes a processing unit and a communication unit operatively connected to the processing unit, the communication unit being configured for providing an indication relating to the sensed condition of the main water line.

In one embodiment, the communication unit is further configured for receiving a command from a user and to transmit the command to the processing unit.

In one embodiment, the condition sensor includes a temperature sensor operatively coupled to the main water line for monitoring a water temperature of the water within the main water line, the predetermined condition including the water temperature being below a predetermined temperature threshold value.

In one embodiment, the condition sensor includes a pressure sensor operatively coupled to the main water line for monitoring a water pressure of the water within the main water line.

In one embodiment, the predetermined condition includes the water pressure being above a predetermined maximum pressure threshold value.

In one embodiment, the predetermined condition includes the water pressure being below a predetermined minimum pressure threshold value.

In one embodiment, the condition sensor includes a leak detector configured to detect a water leak from the main water line.

In one embodiment, the leak detector is operatively coupled to the main water line. In one embodiment, the leak detector is positioned proximal a floor below the main water line.

In one embodiment, the leak detector includes a humidity sensor located proximal to the main water line for measuring a humidity level proximal to the main water line, the predetermined condition including the measured level of humidity being above a predetermined humidity threshold value.

In one embodiment, the system further comprises a housing sized and shaped for receiving at least one of the pump, the flow directing device and the controller.

In one embodiment, the system further comprises a power source operatively connected to at least one of the controller, the flow directing device and the pump for providing electrical power thereto.

In one embodiment, the power source includes a battery.

In one embodiment, the battery is rechargeable.

In one embodiment, the system further comprises a gas inlet operatively coupled to the main water line to allow gas to enter the water circuit when the pump is actuated and water is evacuated from the water circuit.

In one embodiment, the gas includes air.

In one embodiment, the system further comprises a water presence detector operatively connected to the controller and operatively coupled to the main water line for detecting presence of water within the main water line, the controller being further configured to stop actuation of the pump when the presence of water in the main water line is no longer detected by the water presence detector.

In one embodiment, the water presence detector includes a first detection unit located proximal the main line inlet and a second detection unit located proximal a dispensing outlet of the main water line, the controller being configured to stop actuation of the pump when both the first and second detection units no longer detect the presence of water within the main water line.

According to another aspect, there is also provided a fire sprinkler system comprising the water circuit purging system as described hereinabove.

According to another aspect, there is also provided a water system for a passenger vehicle, the water system comprising the water circuit purging system as described hereinabove.

In one embodiment, the passenger vehicle includes an aircraft.

In one embodiment, the passenger vehicle includes a boat.

In one embodiment, the passenger vehicle includes a passenger train.

According to another aspect, there is also provided a method for purging a water circuit, the water circuit including a main water line operatively connected to a water source, the method comprising: using a condition sensor, sensing a condition of the main water line; determining whether the main water line is in a predetermined condition based on the sensed condition; upon determining that the main water line is in the predetermined condition: moving a flow directing device operatively coupled to the main water line from an operative configuration in which the main water line is in fluid communication with the water source to allow water to be provided in the main water line from the water source, and a discharge configuration in which fluid communication between the water source and the main water line is prevented and in which the main water line is in fluid communication with a water discharge line; and actuating a pump operatively coupled to the water discharge line to evacuate water from the water circuit.

In one embodiment, the flow direction device includes a directional valve having a first port operatively coupled to the water source, a second port operatively coupled to the main water line and a third port operatively connected to the water discharge line, and further wherein the moving the flow direction device from the operative configuration to the discharge configuration includes moving the directional valve such that the second and third ports and in fluid communication with each other and fluid communication between the first and second ports are prevented.

In one embodiment, sensing a condition of the main water line includes measuring a water temperature of the water within the water circuit.

In one embodiment, determining whether the main water line is in a predetermined condition includes comparing the measured water temperature with a predetermined temperature threshold value and determining that the measured water temperature is below the predetermined temperature threshold value.

In one embodiment, sensing a condition of the main water line includes detecting a water leak from the main water line.

In one embodiment, determining whether the main water line is in a predetermined condition based includes receiving from the condition sensor an indication of a detection of a water leak.

### BRIEF DESCRIPTION OF THE DRAWINGS

FIG. 1 is a fluid circuit diagram showing a water circuit including a water circuit purging system, in accordance with one embodiment, with the water circuit purging system in a water dispensing mode in which water is dispensed through the water circuit to water-using appliances;

FIG. 2 is a fluid circuit diagram showing the water circuit including the water purging system illustrated in FIG. 1, with the water circuit purging system in a water purging mode in which water is evacuated from the water circuit;

FIG. 3 is a fluid circuit diagram showing a water dispensing circuit including a water circuit purging system, in accordance with another embodiment, in which the water circuit purging system includes a housing for receiving a flow directing device, a pump and a controller of the water circuit purging system;

FIG. 4A is an external side elevation view of the housing for the water circuit purging system illustrated in FIG. 3; and

FIG. 4B is an external front elevation view of the housing for the water circuit purging system illustrated in FIG. 3.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art, that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

For the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

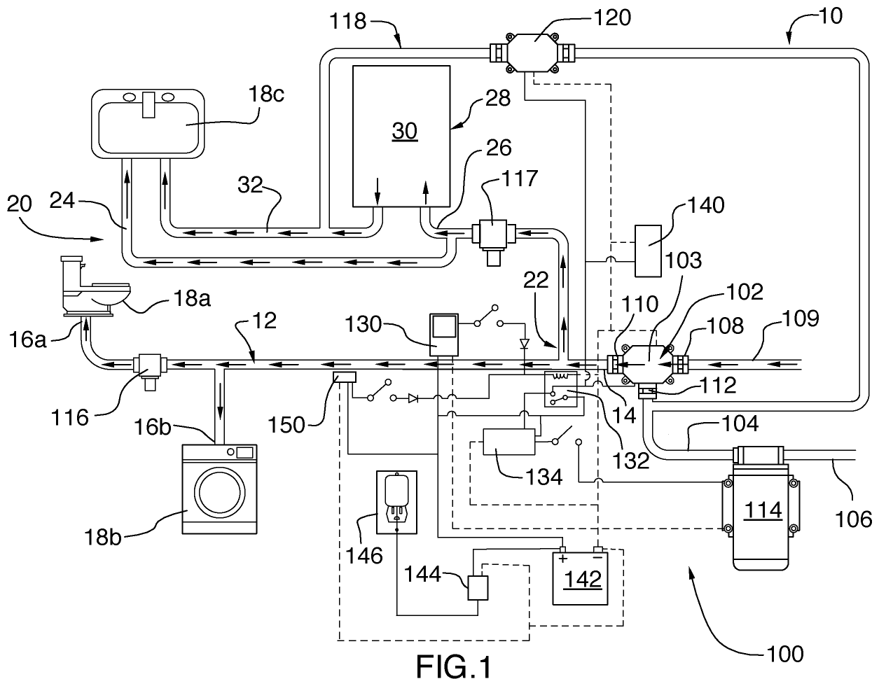

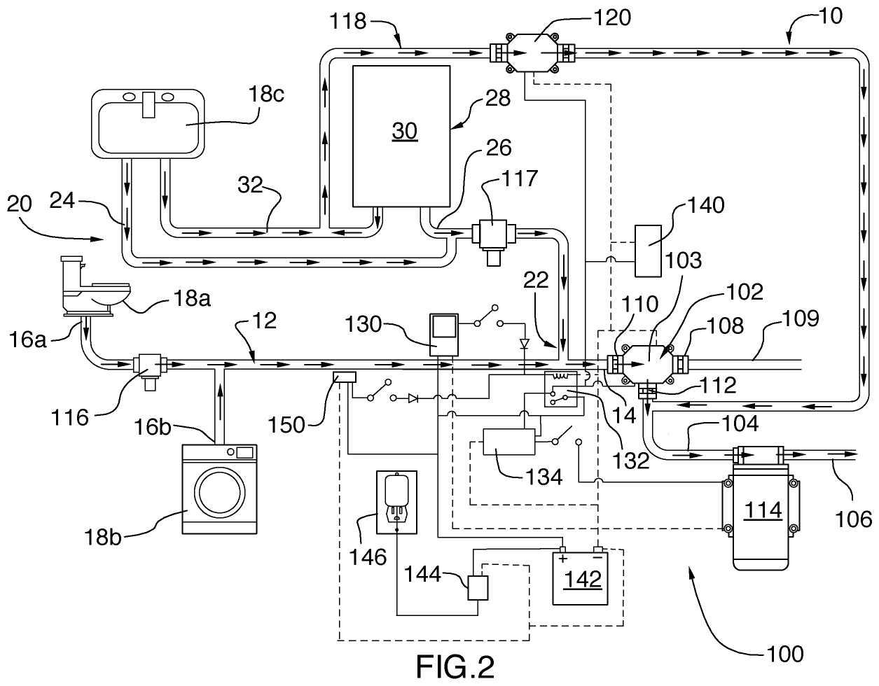

Referring now to FIGS. 1 and 2, there is shown a water circuit 10 and a water circuit purging system 100 for purging water from the water circuit 10, in accordance with one embodiment. In the illustrated embodiment, the water circuit 10 is a domestic water circuit provided in a dwelling such as a house or in a commercial or public building.

The water circuit 10 includes a plurality of interconnected water dispensing lines providing water to a plurality of water-using appliances. In the illustrated embodiment, the water circuit 10 includes a main water line 12 having a main line inlet 14 operatively coupled to a water source, not shown, and a plurality of dispensing outlets 16a, 16b which are each operatively connectable to a water-using appliance 18a, 18b. Specifically, the main water line 12 includes a first dispensing outlet 16a operatively connected to a first water-using appliance 18a and a second dispensing outlet 16b operatively connected to a second water-using appliance 18b. In the illustrated embodiment, the first water-using appliance 18a is a toilet and the second water-using appliance 18b is a washing machine. It will be understood that these water-using appliances are merely provided as examples and that various other water-using appliances may be connected to the dispensing outlets 16a, 16b of the main water line 12. Moreover, although the main water line 12 is illustrated in FIGS. 1 and 2 as having two dispensing outlets 16a, 16b, the water line 12 could instead have a single dispensing outlet or more than two dispensing outlets.

In the illustrated example, the water source may be a domestic water supply source from a public water supply system. Alternatively, the water source may be a water tank which is configured for containing a finite amount of water and which can be refilled as needed.

It will be understood that the water dispensed by the water source is substantially cold water. In the illustrated embodiment, the water circuit 10 further includes a secondary water line 20 which is adapted to provide hot water or both cold and hot water to one or more appliances. More specifically, the secondary water line 20 is operatively connected to the main water line 12 so as to be in fluid communication with the main water line 12. The secondary water line 20 includes a secondary line inlet 22 operatively coupled to the main water line 12 and branches out to define a first water dispensing outlet 24 connectable to a third water-using appliance 18c and a second water dispensing outlet 26 also connectable to the third water-using appliance 18c via a water heating device 28. Specifically, the water heating device 28 may be generally configured as a standard water heater and includes a water tank 30 and a heating element, not shown, configured to heat water in the water tank 30. The secondary water line 20 further includes a hot water delivery line 32 which operatively couples the water tank 30 to the third water-using appliance 18c to deliver to the third water-using appliance 18c heated water from the water heating device 28. It will be understood that while the water dispensed by the water source through the main water line 12 is substantially cold water, this secondary water line 22 allows hot water or both cold water and hot water to be provided to the third water-using appliance 18c and to any other appliance operatively coupled to the secondary water line 22.

In the illustrated embodiment, the third water-using appliance 18c is a faucet for a sink. Alternatively, the third water-using appliance 18c could include a washing machine, a dishwasher or any other water-using appliance which could require hot water or both cold water and hot water.

During normal use of the water circuit 10, water is delivered to the first and second water-using appliances 18a, 18b through the main water line 12 and to the third water-using appliance 18c through the secondary water line 22. In one embodiment, the water circuit 10 could therefore be configured as a standard water circuit as is typically found in existing dwellings.

Still referring to FIGS. 1 and 2, the water line purging system 100 includes a flow directing device 102 operatively coupling the water source and the main water line 12, and a water discharge line 104 operatively coupled to the flow directing device 102 to allow water to be discharged or evacuated from the water circuit 10 to a water discharge outlet 106. In one embodiment, the water discharge outlet 106 can be operatively connected to a public wastewater system. Alternatively, the water discharge outlet 106 can be operatively connected to a water discharge tank, which could include a wastewater tank of the house which is adapted to receive wastewater from the water-using appliances, or a dedicated discharge water reservoir which allows water discharged by the system 100 to be recovered and potentially re-used for other applications.

In the illustrated embodiment, the flow directing device 102 is movable between an operative configuration in which water in which the main water line 12 is in fluid communication with the water source to allow water to be provided in the main water line 12 from the water source, and a discharge configuration in which fluid communication between the water source and the main water line 12 is prevented. Moreover, the flow directing device 102 is configured such that, when the flow directing device 102 is in the operative position, fluid communication between the main water line 12 and the water discharge line 104 is prevented and when the flow directing device 102 is in the discharge configuration, the main water line 12 is in fluid communication with the water discharge line 104. According to this configuration, when the flow directing device 102 is in the discharge configuration, the water circuit 10 is therefore substantially isolated from the water source.

In the illustrated embodiment, the flow directing device 102 includes a three-way directional valve 103 having a first port 108 operatively coupled to the water source via a water source line 109, a second port 110 operatively coupled to the main line inlet 14 and a third port 112 operatively coupled to the water discharge line 104. According to this configuration, when the directional valve is in the operative configuration, the first port 108 is in fluid communication with the second port 110 and fluid communication between the first and third ports 108, 112 is prevented, and when the directional valve is in the discharge configuration, the second port 110 is in communication with the third port 112 and fluid communication between the first and second ports 108, 110 is prevented.

In one embodiment, the directional valve 103 includes an electro-mechanical or solenoid valve. Alternatively, the directional valve 103 could include a hydraulically-actuated valve, a pneumatically-actuated valve, a magnetically-actuated valve or any other types of control valve which a skilled person would consider to be appropriate.

Still in the illustrated embodiment, the system 100 further includes a pump 114 operatively coupled to the water discharge line 104 for pumping water from the water discharge line 104 to the water discharge outlet 106. The pump 114 is configured such that when the flow directing device 102 is in the discharge configuration and the pump 114 is actuated, the pump 114 creates suction sufficient to pump water from the main water line 12, which is in fluid communication with the water discharge line 104, through the water discharge line 104 and towards the water discharge outlet 106 as will be further explained below.

In the illustrated embodiment, the system 100 further includes a main gas inlet 116 operatively coupled to the main water line 12 to allow gas to enter the water circuit 10 when the pump 114 is actuated and water is evacuated from the water circuit 10, the gas thereby taking the place of the water in the main water line 12 when the main water line 12 is drained. Still in the illustrated embodiment, the main gas inlet 116 is located towards the dispensing outlets 16a, 16b of the main water line 12, but alternatively, the gas inlet 116 could be located at another location along the main water line 12. Still in the illustrated embodiment, the system 100 further includes a secondary gas inlet 117 similar to the main gas inlet 116 and operatively coupled to the secondary water line 22.

In one embodiment, the gas may include air adjacent the gas inlet. Alternatively, the gas inlet 116 may be connected to an inert gas source or the like which would provide inert gas into the main water line 12 when the main water line 12 is drained.

In the illustrated embodiment, the system 100 further includes a secondary discharge line 118 extending between the hot water delivery line 32 and the water discharge line 104 for evacuating water from the hot water delivery line 32. Specifically, the system 100 includes a secondary discharge valve 120 operatively connected to the secondary discharge line 118. The secondary discharge valve 120 is movable between a closed position in which fluid communication between the hot water delivery line 32 and the water discharge line 104 is prevented and an open position in which the hot water delivery line 32 and the water discharge line 104 are in fluid communication.

During normal operation of the water circuit 10, the secondary discharge valve 120 is in the closed position. When the flow directing device 102 is moved to the discharge configuration and the pump 114 is actuated, the secondary discharge valve 120 is moved to the open position to allow water in the hot water delivery line 32 to be evacuated therefrom through the secondary discharge line 118 and into the water discharge line 104.

The water line purging system 100 further includes a condition sensor 130 for sensing a condition of the water circuit 10. The condition could include water temperature, water pressure, whether water is leaking from the main water line 12, or one of various other conditions or even a combination of conditions, as will be explained further below. The system 100 further includes a controller 132 operatively connected to the condition sensor 130 for receiving from the condition sensor an indication corresponding to the sensed condition to the controller 132. For example, the indication may include a sensed water temperature of the water within the main water line 12, or an indication that a water leak has been detected.

The controller 132 is further operatively connected to the directional valve 103 and to the pump 114. Specifically, the controller 132 is configured for moving the directional valve 103 between the operative configuration and the discharge configuration based on the indication of the sensed condition received from the condition sensor 130. For example, if the indication is an indication that a water leak has been detected, the controller 132 will move the directional valve 103 from the operative configuration to the discharge configuration and will actuate the pump 114 which will pump water from the main water line 12 into the water discharge line 104 and out the water discharge outlet 106.

It will be understood that since the secondary water line 22 is in fluid communication with the main water line 12, the secondary water line 22 will also be drained when the directional valve 103 is in the discharge configuration and the pump 114 is actuated.

The controller 132 may be configured to move the directional valve 103 in one of various ways. In one embodiment, the directional valve 103 may be biased towards the discharge configuration by one or more resilient members. In this embodiment, the directional valve 103 may need to be energized to be maintained in the operative configuration, either by the controller 132 itself or by an external energy source controlled by the controller 132. To move the directional valve 103 from the operative configuration to the discharge configuration, the controller 132 may simply de-energize the directional valve 103 to allow it to return to the discharge configuration. It will be appreciated that in this configuration, in case of a loss of power to the directional valve 103, to the controller 132 and/or to the entire water circuit purging system 100, the directional valve 103 will automatically be set in the discharge configuration to prevent additional water from entering the water circuit 10 from the water source. To move the directional valve 103 back from the discharge configuration to the operative configuration, the directional valve 103 may simply be re-energized by the controller 132.

In another embodiment, the directional valve 103 may not be biased towards the discharge configuration. Instead, the directional valve 103 may move from the operative configuration to the discharge configuration in response to a first control signal provided by the controller 132 and may move from the discharge configuration to the operative configuration in response to a second control signal provided by the controller 132. In this embodiment, in case of a loss of power to the system 100 when the directional valve 103 is in the operative configuration, the directional valve 103 would remain in the operative configuration rather than move automatically to the discharge position.

In the illustrated embodiment, the controller 132 is further operatively connected to the secondary discharge valve 120 and is configured to further move the secondary discharge valve 120 into the open position when the pump 114 is actuated. The pump 114 will thereby pump water from the hot water delivery line 32 through the secondary discharge line 118 and into the water discharge line 104 to be discharged through the water discharge outlet 106.

In one embodiment, the system 100 may further be manually configured in a manual override configuration in which water is evacuated from the water circuit 10, regardless of the condition sensed by the condition sensor 130. Specifically, the controller 132 may be configured such that, upon receiving a corresponding command from a user, the controller 132 moves the directional valve 103 to the discharge configuration and activates the pump 114 for a finite amount of time to evacuate water from the water circuit 10. It will be appreciated that this configuration could be used when an occupant of a dwelling in which the system 100 is used leaves the dwelling unattended for a relatively long period of time. This would ensure that water can no longer enter the water circuit 10 from the water source and that the water circuit 10 remains substantially empty to thereby prevent the formation of any leaks even in conditions which may contribute to the formation of leaks such as ambient temperature falling below 0° C. for example. From this configuration, the directional valve 103 could then be moved back to the operative configuration, or “reset”, by the controller 132 when the controller 132 receives a corresponding command.

In one embodiment, the controller 132 could include a microcontroller, a personal computer or any other types of controllers which may be used to actuate the pump 114, the directional valve 103 and the condition sensor 130. Alternatively, the controller 132 may simply be a relay which may be triggered by the indication of the sensed condition of the water circuit 10 provided by the condition sensor 130.

Moreover, the controller 132 may be configured for actuating the pump for a predetermined amount of time corresponding for a time considered sufficient to completely drain the water circuit. For example, in an embodiment in which the controller 132 is a relay, the controller 132 may be operatively connected to a timed switch 134 which would maintain the pump 114 actuated only for the predetermined amount of time.

In another embodiment, the system 100 could instead include one or more water detectors positioned inside the water circuit 10 to detect the presence of water inside the water circuit. The controller 132 may be operatively connected to the water detectors and may be configured to stop actuation of the pump 114 only when the presence of water is no longer detected in the water circuit 10, which indicates that the water circuit 10 has been fully drained of water. For example, the system 100 may include at least one water detector in the main water line 12 and at least one water detector in the secondary water line 22. Specifically, the system 100 may include a first water detector positioned within the main water line 12 proximal to the main line inlet 14 and a second water detector positioned within the main water line 12 proximal to one of the dispensing outlets 16a, 16b. Alternatively, the water detectors may be positioned at various other locations along the water circuit 10.

Once actuation of the pump 114 has been stopped, the directional valve 103 must be moved back from the discharge configuration to the operative configuration manually by a user. Alternatively, the controller 132 may be configured to automatically move the directional valve 103 back from the discharge configuration to the operative configuration upon receiving an indication that the water circuit 10 is no longer in the predetermined condition. For example, the controller 132 may automatically move the directional valve 103 back from the discharge configuration to the operative configuration upon detection that the water temperature has increased to above the predetermined threshold value.

In one embodiment, the controller 132 is further operatively connected to a communication unit 140 which is configured for providing indications regarding a status of the system to a receiver located remotely from the controller 132. The indications regarding the status of the system could include an indication that the system 100 has been activated, for example. The indications could further include the indication of the sensed condition provided by the condition sensor 130.

In one embodiment, the communication unit 140 is further configured for receiving commands from a transmitter and to send the received commands to the controller. The transmitter could include a smartphone or a personal computer operated by a user, for example, and the commands could include a command to move the directional valve 103 back from the discharge configuration to the operative configuration or a command to arm/disarm the system. The command could also include a command to modify the predetermined threshold value stored in the memory. Various other commands could also be provided.

In one embodiment, the communication unit 140 is adapted to send indications and receive commands wirelessly using a wireless communication means such as SMS, WiFi, Bluetooth, the Internet or the like. Alternatively, the communication unit 140 could be operatively connected to one or more receiver, transmitter or receiver/transmitter using one or more wires to form a wired connection therebetween.

In another embodiment, instead of being configured for receiving commands wirelessly through the communication unit 140, the controller 132 could include a local user interface, not shown, such as a keypad, a touchscreen, or any other types of interfaces which could allow a user to provide commands to the controller 132.

In the illustrated embodiment, the system 100 further includes a power source 142 operatively connected to the controller 132, to the directional valve 103, to the pump 114, to the secondary discharge valve 120 and to the condition sensor 130 to power these elements. In one embodiment, the power source 142 is a battery.

In this embodiment, the system 100 is therefore independent from a local power grid and may therefore continue operating during a power failure. It will be appreciated that this may be particularly advantageous in case where an inside or outside ambient temperature is relatively low since heating systems of the dwelling are likely to fail during a power failure, thereby increasing the chances of the water inside the water circuit 10 freezing and damaging the water lines.

In the illustrated embodiment, the system 100 further includes a battery charger 144 which can be operatively connected to an electrical outlet 146 connected to a local power grid. This ensures that the battery remains charged when the power grid is active and that the system 100 may continue to work in case of a power failure. Alternatively, the system 100 could instead be operatively connected directly to the power grid, which would act as a power source to power the elements of the system 100.

In another embodiment, instead of including a single power source, the system 100 could include a plurality of power sources, each power source being operatively connected to one of the controller 132, the directional valve 103, the pump 114 and the secondary discharge valve 120.

It will be understood that various types of sensors and combination of sensors may be used for sensing a condition of the water circuit 10 which would be indicative of a water leak and/or or water freezing within the water circuit 10.

In one embodiment, the condition sensor 130 includes a water temperature sensor operatively coupled to the water circuit 10 for measuring a water temperature of the water within the water circuit 10. Specifically, the water temperature sensor is located adjacent the main water line 12 and extends into the main water line 12 so as to be in contact with the water circulating through the main water line 12.

In one embodiment, the main water line 12 may include a main water conduit having a main conduit sidewall, and the water temperature sensor could be in contact with the main conduit sidewall to thereby monitor the water temperature indirectly by monitoring a temperature of the main conduit sidewall.

The measured water temperature may then be provided to the controller 132. Specifically, the controller 132 may include a processing unit and the water temperature sensor may be operatively connected to the processing unit to thereby provide the measured temperature to the processing unit. In addition to the processing unit, the controller 132 may further include a memory operatively connected to the processing unit, which may be used to store a predetermined temperature threshold value. The processing unit is configured for comparing the measure water temperature with the predetermined temperature threshold value.

In another embodiment, the water temperature sensor could include a plurality of water temperature sensing units located at different locations along the water circuit 10. For example, the water temperature sensor could include a first water temperature sensing unit operatively coupled to the main water line 12 and a second water temperature sensing unit operatively coupled to the secondary water line 20. In another example, the water temperature sensor could include a first water temperature sensing unit operatively coupled to the main water line 12 and located proximal to the main line inlet 14, and a second temperature sensing unit located near the first or second dispensing outlets 16a, 16b of the main water line 12.

In yet another embodiment, the condition sensor 130 could include an ambient temperature sensor located proximal to the main water line 12. In this embodiment, instead of directly monitoring the water temperature, the ambient temperature sensor would measure an ambient temperature which is substantially indicative of the water temperature of the water within the water circuit 10.

In this case, the memory could contain a predetermined ambient temperature threshold value instead of the predetermined water temperature threshold value. For example, it may be predetermined that when the ambient temperature falls below a predetermined ambient temperature threshold value, such as 0° C., there is a significant risk that the water within the water circuit could freeze or start freezing. In this case, the controller 132 may be configured to move the directional valve 103 to the discharge configuration when the controller 132 receives from the ambient temperature sensor an indication that the ambient temperature is below the predetermined ambient temperature threshold value.

In one embodiment, the ambient temperature sensor could include a temperature sensor of a standard domestic thermostat provided in a room of the house in which at least a portion of the water circuit 10 is located. Alternatively, the ambient temperature sensor may include a dedicated ambient temperature sensor which is provided in the room of the dwelling in which at least a portion of the water circuit 10 is located. In another embodiment, the ambient temperature sensor may include a plurality of ambient temperature sensing units, each ambient temperature sensing unit being located in a specific room or area of the building.

It will be understood that the main water line 12 and the secondary water line 20 are typically located inside the walls of the building. In this case, the condition sensor 130 could include an ambient temperature sensor which is also located within the walls of the building, proximal to the main water line 12 and/or the secondary water line 20.

In another embodiment, the condition sensor 130 could include a pressure sensor for measuring a water pressure inside the main water line. For example, a change in pressure within the main water line may be indicative of water being frozen or starting to freeze in the main water line. Specifically, an increase in pressure may be indicative of water being frozen or starting to freeze downstream of the condition sensor 130, while a decrease in pressure may be indicative of water being frozen or starting to freeze upstream of the condition sensor 130.

In one embodiment, the controller 132 could be configured for moving the flow directing device 102 from the operative configuration to the discharge configuration and actuating the pump 114 when the measured pressure is above a predetermined maximum pressure threshold value. The controller 132 could further be configured for moving the flow directing device 102 from the operative configuration to the discharge configuration and actuating the pump 114 when the measured pressure is below a predetermined minimum pressure threshold value.

In one embodiment, the pressure sensor is a water pressure transducer which extends into the main water line 12. Alternatively, the pressure sensor could be configured to indirectly measure the water pressure of the water within the main water line 12. For example, in an embodiment in which the main water line 12 is a conduit having a conduit sidewall, the pressure sensor could include one or more strain gauges disposed against the conduit sidewall for measuring strain on the conduit which may be indicative of a change in pressure within the main water line 12.

Alternatively, the pressure sensor could include any other type of pressure sensors which a skilled person would consider to be suitable.

In yet another embodiment, the condition sensor includes a leak detector 150 which is configured to detecting a water leak from the water circuit 10 and provide an indication of the detection of the water leak to the controller 132. For example, the leak detector 150 could be operatively coupled to the main water line 12 and detect a presence of water on an outer surface of the main water line 12, which would be indicative of a water leak. It will be appreciated that in some circumstances, condensation may form on the outer surface of the main water line 12. Therefore, the leak detector 150 could be calibrated so as to provide the indication of the detection of the water leak only when a predetermined minimum amount of water is detected on the outer surface of the main water line 12.

In this embodiment, the “condition” sensed by the leak detector 150 would therefore be whether or not water is leaking from the main water line 12, and the “predetermined condition” in which the controller 132 acts to move the flow directing device 102 from the operative configuration to the discharge configuration would be the fact that a water leak has been detected.

In one embodiment, the leak detector 150 could include a plurality of leak detection units positioned along the main water line 12 and spaced from each other at certain intervals to be able to detect water leaks at different locations along the main water line 12. Alternatively, the leak detector 150 could instead be elongated and extend continuously along the main water line 12.

In yet another embodiment, the leak detector 150 may not be coupled to the main water line 12, but may instead be disposed proximal a floor below the main water line 12. In this embodiment, the leak detector 150 may be configured to detect a presence of water on the floor, which would be indicative that water is leaking from the main water line 12 and onto the floor below. It will be appreciated that this type of leak detector could be integrated into baseboards of the room or in the floor itself to remain inconspicuous and therefore to avoid detracting from the room's appearance.

In another embodiment, the leak detector 150 may include a humidity sensor such as a hygrometer or a humidistat positioned in a room or area in which the main water line 12 is located to measure an ambient humidity level. In this embodiment, the controller 132 is operatively connected to the humidity sensor and is configured for moving the flow directing device 102 from the operative configuration to the discharge configuration and actuating the pump 114 upon receiving an indication that the ambient humidity level is above a predetermined humidity threshold value.

In still another embodiment, the leak detector 150 could include one or more cameras pointed at the main water line 12 or at the floor below the main water line 12. The cameras may be configured to capture images of the main water line 12 and/or of the floor below the main water line 12. For example, in an embodiment in which the main water line 12 or at least a portion of the main water line 12 is located within a wall of a building and is therefore enclosed in the wall, the cameras could also be enclosed in the wall proximal to the main water line 12 to be able to capture images of the main water line 12 even though the main water line 12 itself may not be directly accessible to a user. The cameras may be placed inside the wall when the wall is built and the main water line 12 is enclosed in the wall or, alternatively, may be placed in the wall at a later time through an opening in the wall.

In this embodiment, the processing unit may be configured to receive the images from the cameras and to process the images using one or more image processing algorithms to determine whether the images captured by the cameras contain an indication of a water leak from the main water line. Alternatively, instead of the images being processed by the processing unit, the communication unit 140 may be configured for transmitting the images to a remote processing unit which may process the images using one or more image processing algorithms to determine whether the images captured by the cameras contain an indication of a water leak from the main water line. In one embodiment, the communication unit 140 may be configured for transmitting the images to a display unit, such as a personal computer or a smartphone of a user, to allow the user to visualize the images captured by the cameras.

It will be understood that the condition sensor 130 may include any of the sensors described above or any combination of any of the sensors described above.

It will further be appreciated that in addition to the sensors described above, the condition sensor 130 could include any other type of sensors which a skilled person would consider appropriate to provide an indication of a condition corresponding to the freezing of water in the water circuit 10 and/or to detect a water leak from the water circuit 10.

It will further be understood that although in some embodiments above the conditions sensor 130 was described as being operatively coupled to the main water line, the condition sensor could instead be positioned at another location along the water circuit 10. For example, the condition sensor 130 could instead be operatively coupled to the secondary water line 20, to one of the water-using appliances, to the directional valve 103 or to any other elements of the water circuit 10.

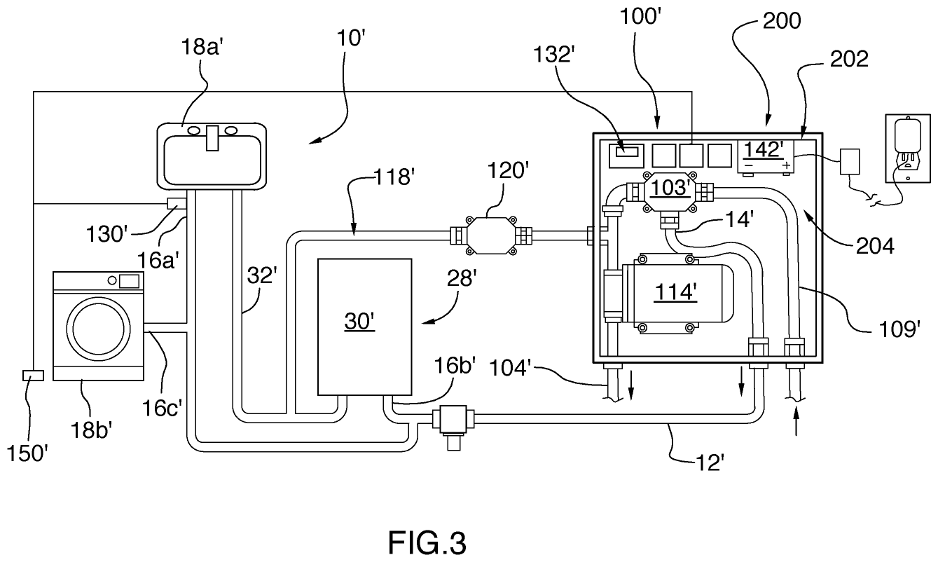

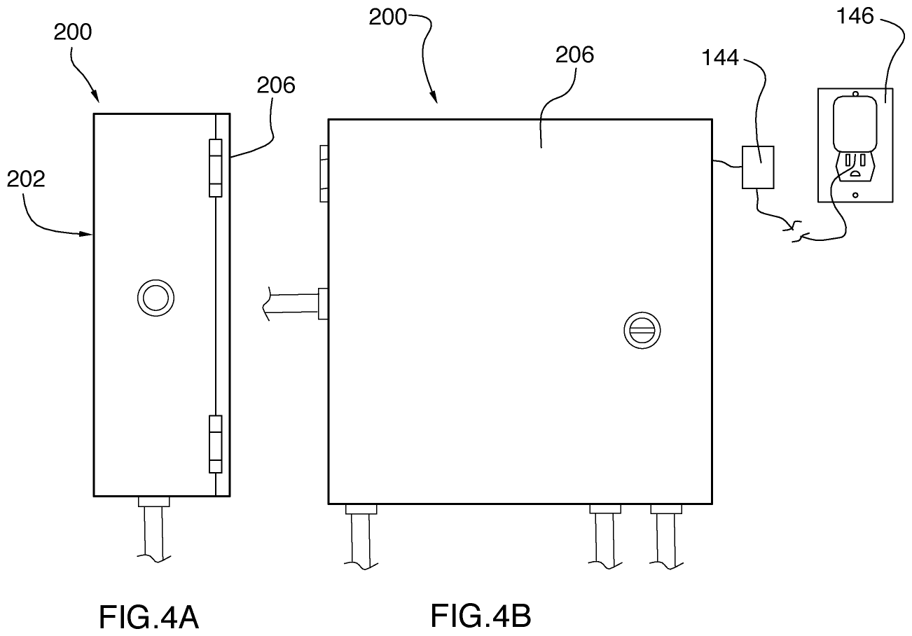

Turning to FIGS. 3 to 4B, there is shown a water circuit 10′, in accordance with another embodiment. In this embodiment, the water circuit 10′ is substantially similar to the water circuit 10 illustrated in FIGS. 1 and 2 and includes a main water line 12′ operatively coupled to a water source. In the embodiment illustrated in FIGS. 3 to 4B, the main water line 12′ is generally configured similarly to the secondary water line 22 of the water circuit 10 illustrated in FIGS. 1 and 2. Specifically, the main water line 12′ includes a main line inlet 14′ operatively coupled to a directional valve 103′, a first dispensing outlet 16a′ operatively coupled to a first water-using appliance 18a′ such as a faucet, a second water dispensing outlet 16b′ also connectable to the first water-using appliance 18a′ via a water heating device 28′ including a water tank 30′, and a third water dispensing outlet 16c′ located proximal the first dispensing outlet 16a′ and operatively coupled to a second water-using appliance 18b′. The main water line 12′ further includes a hot water delivery line 32′ which operatively couples the water tank 30′ to the third water-using appliance 18a′ to deliver to the first water-using appliance 18a′ heated water from the water heating device 28′.

In one embodiment, the water circuit 10′ could further includes one or more secondary water lines operatively coupled to the main water line 12′ to provide water to additional water-using appliances.

The water circuit 10′ is further provided with a water circuit purging system 100′ which is substantially similar to the water circuit purging system 100. In the embodiment illustrated in FIGS. 3 to 4B, the water circuit purging system 100′ includes the directional valve 103′, a water discharge line 104′, a pump 114′, a controller 132′, a power source 142′, a condition sensor 130′ and a leak detector 150′ which are generally similar to the directional valve 103, water discharge line 104, pump 114, controller 132, power source 142, condition sensor 130 and leak detector 150 of the system 100 illustrated in FIGS. 1 and 2.

In the embodiment illustrated in FIGS. 3 to 4B, the system 100′ further includes a housing 200 adapted to house the directional valve 103′, the pump 114′, the controller 132′ and the power source 142′. Specifically, the housing 200 includes a rectangular housing body 202 defining an inner cavity 204 for receiving the elements of the water circuit purging system 100′ and a hinged cover 206 which can be opened to allow access to the elements of the water circuit purging system 100′ disposed in the inner cavity 204. It will be appreciated that providing most of the elements of the water circuit purging system 100′ in a housing facilitates providing and installing the water circuit purging system 100′ on an existing water circuit.

The system 100′ further includes a secondary discharge line 118′ extending between the hot water delivery line 32′ and the water discharge line 104′ for evacuating water from the hot water delivery line 32′. Specifically, the system 100′ includes a secondary discharge valve 120′ operatively connected to the secondary discharge line 118′, similarly to the secondary discharge valve 120. In the embodiment illustrated in FIGS. 3 to 4B, the secondary discharge valve 120′ is located outside the housing 200. However, in another embodiment, the secondary discharge valve 120′ could instead be housed in the housing 200.

It will be understood that the above configuration is merely provided as an example, and that various alternative configurations may be considered. For example, the water circuit 10 may not include a secondary water line. In this embodiment, the water circuit 10 may therefore only be adapted to provide cold water to one or more water-using appliances. In another embodiment, the water circuit 10 may not include a secondary water line and the main water line may be configured substantially similarly to the secondary water line described above. More specifically, the main water line may branch out into a cold water dispensing line portion operatively connected to a water-using appliance and a hot water dispensing line portion operatively connected to the water-using appliance via a water heating device to dispense hot water to the water-using appliance. In this configuration, all water-using appliances could be operatively coupled to the water heating device so as to be provided with hot water if desired, in addition to cold water.

It will be understood that in other embodiments, the water circuit may include a plurality of main water lines and a plurality of secondary water lines which may be intercoupled in various arrangements.

It will further be understood that although the flow directing device 102 is illustrated as a self-contained directional valve, other arrangements which could provide the same configurations are possible. For example, instead of including a single directional valve, the flow directing device 102 could instead include a plurality of valves which would be arranged so as to provide the same functionalities as a directional valve. More specifically, the flow directing device 102 could instead include a first two-way valve operatively coupling the water source to the main water line and a second two-way valve operatively coupling the main water line to the water discharge line.

In another embodiment, instead of being coupled to a water circuit of a building, the water line purging system 100 could instead be operatively coupled to a water system for a passenger vehicle, such as an aircraft for example. Specifically, the water system for an aircraft may include one or more water lines extending between a utility water reservoir and one or more lavatories of the aircraft, each lavatory including at least one of a toilet and a faucet for a sink. The water system of the aircraft could further include a potable water reservoir which is adapted to contain potable water or galley water which may be provided through one or more water lines to a galley water outlet adapted to dispense potable water to be used in the preparation of beverages and food items. The water system of the aircraft may further include a wastewater reservoir and one or more water lines extending between the wastewater reservoir and the lavatories to temporarily store wastewater from the lavatories.

It will be understood that when the aircraft is not in use and is stored for a period of time, an operator of the aircraft or a maintenance worker is usually required to manually purge the aircraft's water system. Unfortunately, this procedure may be overlooked. In this case, if the ambient temperature falls below a certain ambient temperature, the water left in the water lines may freeze and thereby expand, especially if the aircraft is left outdoors or in a non-heated storage area overnight.

This may damage the water lines and cause water to leak out of the water lines, which may in turn damage the aircraft.

The water circuit purging system 100 described hereinabove would therefore prevent the aircraft from being damaged in this manner. Specifically, the flow directing device could operatively connect one or more water lines of the water system to the utility water reservoir and/or the potable water reservoir. In this embodiment, the condition sensor could include a water temperature sensor to directly measure a water temperature of the water in the water lines or an ambient temperature sensor located proximal the water lines, such as in a fuselage compartment of the aircraft in which the water lines are located. Alternatively, the condition sensor could instead include a pressure sensor or a leak detector as described above, or any other condition sensor which a skilled person would consider to be appropriate.

In this embodiment, the water discharge line of the water circuit purging system 100 may be operatively coupled to a wastewater tank provided on the aircraft to be mixed with other wastewater, such as wastewater from the lavatories for example. Alternatively, the water discharge line could instead be operatively coupled to the utility water reservoir to be mixed with the utility water and therefore be re-introduced in the water lines to provide water to the lavatories.

In yet another embodiment, the water discharge line could instead be operatively coupled to a dedicated discharge reservoir. Specifically, the water discharge reservoir could be collapsible and include a flexible sidewall. For example, the flexible sidewall could include bellows to allow it to be stored substantially flat when empty and to unfold when being filled. Alternatively, the dedicated discharge reservoir may include a flexitank. Specifically, the flexible sidewall of the dedicated discharge reservoir may include an extendable membrane which would allow the dedicated discharge reservoir to be stored substantially flat when empty and to occupy only the volume of the water received in the dedicated discharge reservoir.

It will be appreciated that the same configuration could be applied to other types of passenger vehicles. For example, the water line purging system 100 could instead be operatively coupled to a water system for a boat. The boat could be a small recreational boat such as a cabin cruiser, a houseboat, a yacht, a cruise ship, a cargo ship or any other type of boat which is adapted to receive passengers and/or crew members and which includes at least one water-using appliance.

In yet another embodiment, a water line purging system 100 could instead be operatively coupled to a water system of a train such as a passenger train, of a submarine, of a recreational vehicle (RV), of a passenger bus, or of any other vehicle including at least one water-using appliance.

Alternatively, instead of being coupled to a water circuit of a building or of a passenger vehicle, the system 100 may be used with other types of water circuits adapted to deliver water to a water-using or water dispensing device. For example, the water circuit purging system 100 described above may be operatively coupled to a fire sprinkler system which may be found in a residential, commercial or public building. A fire sprinkler system typically includes a plurality of water lines operatively connected to a water source such as a water supply source from a public water supply system. The water lines extend through multiple areas or rooms of the building, proximal to a ceiling of the building. The fire sprinkler system further includes a plurality of sprinkler nozzles in fluid communication with the water lines to provide a stream or spray of water into the room in which they are located upon detection of a certain level of heat, smoke and/or fire by a corresponding sensor disposed in the room or at another location in the building. It will be understood that, similarly to the water circuit 10 for the dwelling or the water circuit for an aircraft or another vehicle as described above, water in the water lines may freeze and expand if the building is not properly heated for a certain period of time. This may damage the water lines and cause water to leak from the water lines into the room below, thereby causing damage to the building.

In one embodiment, the water circuit purging system 100 may therefore be integrated to the fire sprinkler system such that the flow directing device operatively couples the water lines to the water source, which allows the dispensing of water from the water source to be stopped and the water in the water lines to be drained from the fire sprinkler system if a predetermined condition of the fire sprinkler system is detected, as described above.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the invention as defined in the claims appended hereto.

1. A water circuit purging system for purging water from a water circuit, the water circuit including a main water line having an inlet connected to a water source for dispensing water into the main water line, the system comprising:
a water discharge line for evacuating water from the main water line;
a flow directing device operatively coupling the main water line to the water source and the water discharge line, the flow directing device being movable between an operative configuration in which the main water line is in fluid communication with the water source to allow water to be provided in the main water line from the water source and in which fluid communication between the main water line and the water discharge line is prevented, and a discharge configuration in which fluid communication between the water source and the main water line is prevented and in which the main water line is in fluid communication with the water discharge line;
a pump operatively coupled to the water discharge line for pumping water from the water discharge line to a water discharge outlet when the flow directing device is in the discharge configuration;
a condition sensor for sensing a condition of the main water line; and
a controller operatively connected to the condition sensor, to the flow directing device and to the pump, the controller being configured to receive an indication of the sensed condition from the condition sensor, to determine that the main water line is in a predetermined condition based on the sensed condition and to move the flow directing device from the operative configuration to the discharge configuration upon determination that the main water line is in the predetermined condition.

2. The system as claimed in claim 1, wherein the flow directing device comprises a directional valve system, the directional valve system comprising one or more directional valves.

3. The system as claimed in claim 2, wherein the directional valve is an electro-mechanical valve.

4. The system as claimed in claim 3, wherein the electro-mechanical valve is a three-way electro-mechanical valve.

5. The system as claimed in claim 1, wherein the water discharge outlet is operatively coupled to a domestic wastewater system.

6. The system as claimed in claim 1, wherein the water discharge outlet is operatively coupled to a discharge water reservoir including an extendable sidewall being a flexitank for storing water evacuated from the main water line through the water discharge line.

7. (canceled)

8. (canceled)

9. The system as claimed in claim 1, wherein the controller includes a processing unit and a communication unit wirelessly connected to the processing unit with one or a combination of communication means being SMS, WiFi, Bluetooth and the Internet, the communication unit being configured for providing an indication relating to the sensed condition of the main water line.

10. The system as claimed in claim 9, wherein the communication unit is further configured for receiving a command from a user and to transmit the command to the processing unit.

11. The system as claimed in claim 1, wherein the condition sensor includes a temperature sensor operatively coupled to the main water line for monitoring a water temperature of the water within the main water line, the predetermined condition including the water temperature being below a predetermined temperature threshold value.

12. (canceled)

13. (canceled)

14. (canceled)

15. The system as claimed in claim 1, wherein the condition sensor includes a leak detector operatively coupled to the main water line and configured to detect a water leak from the main water line.

16. (canceled)

17. The system as claimed in claim 15, wherein the leak detector is positioned proximal a floor below the main water line.

18. The system as claimed in claim 15, wherein the leak detector includes a humidity sensor located proximal to the main water line for measuring a humidity level proximal to the main water line, the predetermined condition including the measured level of humidity being above a predetermined humidity threshold value.

19. The system as claimed in claim 1, further comprising a housing sized and shaped for receiving at least one of the pump, the flow directing device and the controller.

20. The system as claimed in claim 1, further comprising a rechargeable battery acting as a power source operatively connected to at least one of the controller, the flow directing device and the pump for providing electrical power thereto.

21. (canceled)

22. (canceled)

23. The system as claimed in claim 1, further comprising a gas inlet operatively coupled to the main water line to allow gas to enter the water circuit when the pump is actuated and water is evacuated from the water circuit.

24. (canceled)

25. The system as claimed in claim 1, further comprising a water presence detector operatively connected to the controller and operatively coupled to the main water line for detecting presence of water within the main water line, the controller being further configured to stop actuation of the pump when the presence of water in the main water line is no longer detected by the water presence detector.

26. (canceled)

27. (canceled)

28. (canceled)

29. (canceled)

30. (canceled)

31. (canceled)

32. A method for purging a water circuit, the water circuit including a main water line operatively connected to a water source, the method comprising:
using a condition sensor operatively connected to a controller, sensing a condition of the main water line;
determining whether the main water line is in a predetermined condition based on the sensed condition;
upon determining that the main water line is in the predetermined condition and with the controller:
moving a flow directing device operatively coupled to the main water line from an operative configuration in which the main water line is in fluid communication with the water source to allow water to be provided in the main water line from the water source, and a discharge configuration in which fluid communication between the water source and the main water line is prevented and in which the main water line is in fluid communication with a water discharge line; and
actuating a pump operatively coupled to the water discharge line to evacuate water from the water circuit.

33. The method as claimed in claim 32, wherein the flow direction device includes a directional valve having a first port operatively coupled to the water source, a second port operatively coupled to the main water line and a third port operatively connected to the water discharge line, and further wherein the moving the flow direction device from the operative configuration to the discharge configuration includes moving the directional valve such that the second and third ports and in fluid communication with each other and fluid communication between the first and second ports are prevented.

34. The method as claimed in claim 32, wherein sensing a condition of the main water line includes measuring a water temperature of the water within the water circuit and wherein determining whether the main water line is in a predetermined condition includes comparing the measured water temperature with a predetermined temperature threshold value and determining that the measured water temperature is below the predetermined temperature threshold value.

35. (canceled)

36. The method as claimed in claim 32, wherein sensing a condition of the main water line includes detecting a water leak from the main water line and wherein determining whether the main water line is in a predetermined condition based on the sensed condition includes receiving from the condition sensors an indication of a detection of a water leak.

37. (canceled)
